(19) United States
(12) Patent Application Publication
(10) Pub. No.: US 2005/0148681 A1
(43) Pub. Date: Jul. 7, 2005

(54) Photoinitiator and ink

(76) Inventor: Catherine A. Schoen, New York, NY (US)

Correspondence Address: HARNESS, DICKEY & PIERCE, P.L.C., P.O. BOX 828, BLOOMFIELD HILLS, MI, 48303, US

(21) Appl. No.: 10/955,979

(22) Filed: Sep. 30, 2004

Related U.S. Application Data
(60) Provisional application No. 60/508,129, filed on Oct. 2, 2003.

(51) Int. Cl. C08G 2/00

(52) U.S. Cl. 522/7

(57) ABSTRACT

An ink jet ink that includes a photopolymerizable material, a pigment, and a liquid blend of (a) oligo [2-hydroxy-2-methyl-1-[4-(1-methylvinyl)phenyl]propanone](b) 4-methylbenzophenonone (c) 2,4,6-trimethylbenzophenone (d) 2,4,6-trimethylbenzoyldiphenylphosphine oxide, (e) phenyl-bis-(2,4,6-trimethylbenzoyl)phosphine oxide, and (f) 2-hydroxy-2-methyl-1-phenylpropanone can be cured by either a xenon flash lamp or a mercury vapor lamp, with excellent adhesion over vinyl substrates.

### FIELD OF THE INVENTION

The invention relates to UV curable compositions, and particularly to UV curable ink jet inks and methods of ink jet printing.

### BACKGROUND OF THE INVENTION

Ink jet inks must have a very low viscosity, typically less than about 20 centipoise at the jetting temperature. While hot melt inks have been used, liquid inks are generally more suited to high volume industrial printing. One way to achieve this low viscosity is by including a substantial amount of organic liquids. In general, ink containing a substantial amount of organic liquids would produce undesirable emissions during the printing process. Such emissions are substantially avoided, however, with energy curable inks. Energy curable inks use low viscosity reactive materials to attain the desired viscosity. The reactive materials have reactive groups that are cured after printing with radiation, such as UV radiation or electron beams.

The energy to induce UV curing may be generated from different sources. The UV light sources mainly used for curing inks are mercury vapor lamps and xenon flash lamps. For optimum efficiency, the ink should contain a photoinitiator that absorbs energy at the strongest emission wavelengths of the energy source. When the emission spectrum for the energy source is matched by the absorption spectrum for the photoinitiator, less photoinitiator is needed to absorb the energy needed to achieve a desired cure rate for the ink. The absorption spectrum for a photoinitiator depends upon its structure; thus, each compound has its own unique peaks of absorption.

While in the optimum situation a UV curing ink would be formulated to match the output spectrum of a particular energy source, in the commercial world it would be desirable to have inks that would have an excellent cure response for as many kinds of energy sources as possible. In such a situation the ink could find utility in a wider segment of the market.

### SUMMARY OF THE INVENTION

The invention provides a combination of photoinitiators that absorb sufficient energy emitted from a mercury vapor lamp and sufficient energy from a xenon flash lamp to cure a photopolymerizable composition. In particular, the invention provides a combination of photoinitiators comprising a blend of

(1) 2-hydroxy-2-methyl-1-phenylpropanone, a derivative thereof such as oligo [2-hydroxy-2-methyl-1-[4-(1-methylvinyl )phenyl]propanone], or a combination thereof;

(2) an alkyl-substituted benzophenone, particularly a methyl-substituted benzophenone, or a combination thereof; and

(3) phenyl-bis-(2,4,6-trimethylbenzoyl)phosphine oxide, optionally in combination with 2,4,6-trimethylbenzoyldiphenylphosphine oxide and/or one or more other substituted 2,4,6-trimethylbenzoyldiphenylphosphine oxides.

The invention further provides an ultraviolet light-curable ink jet ink comprising a sufficient amount of this combination of photoinitiators (1)-(3) so that the printed ink cures when exposed to either xenon flash lamps or mercury vapor lamps.

In a particularly preferred embodiment, the invention provides a combination of photoinitiators comprising a liquid blend of

(a) oligo [2-hydroxy-2-methyl-1-[4-(1-methylvinyl)phenyl]propanone]

(b) 4-methylbenzophenonone

(c) 2,4,6-trimethylbenzophenone

(d) 2,4,6-trimethylbenzoyldiphenylphosphine oxide,

(e) phenyl-bis-(2,4,6-trimethylbenzoyl)phosphine oxide, and

(f) 2-hydroxy-2-methyl-1-phenylpropanone.

The invention further provides an ultraviolet light-curable ink jet ink comprising a sufficient amount of this combination of photoinitiators (a)-(f) so that the printed ink cures when exposed to either xenon flash lamps or mercury vapor lamps.

The invention further provides an ink jet printing method in which an ink jet printer prints the ink jet ink of the invention onto a substrate and the ink is cured with xenon flash and/or medium-pressure mercury vapor lamps.

“A” and “an” as used herein indicate “at least one” of the item is present; a plurality of such items may be present, unless the context clearly dictates otherwise. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

### DETAILED DESCRIPTION OF THE PREFERRED EMBODIMENTS

The following description of the preferred embodiment(s) is merely exemplary in nature and is in no way intended to limit the invention, its application, or uses.

The photoinitiator of the invention is a blend of

(1) 2-hydroxy-2-methyl-1-phenylpropanone, a derivative thereof such as oligo [2-hydroxy-2-methyl-1-[4-(1-methylvinyl)phenyl]propanone] or other derivatives with substituents on the phenyl ring, or a combination thereof;

(2) an alkyl-substituted benzophenone, particularly a methyl-substituted benzophenone, or a combination thereof; and

(3) phenyl-bis-(2,4,6-trimethylbenzoyl)phosphine oxide, optionally in combination with 2,4,6-trimethylbenzoyldiphenylphosphine oxide and/or another substituted 2,4,6-trimethylbenzoyldiphenylphosphine oxide.

The photoinitiator of the invention absorbs sufficient energy emitted from a mercury vapor lamp and sufficient energy from a xenon flash lamp to cure a photopolymerizable composition.

A preferred combination of photoinitiators comprising a liquid blend of

(a) oligo [2-hydroxy-2-methyl-1-[4-(1-methylvinyl )phenyl]propanone]

(b) 4-methylbenzophenonone

(c) 2,4,6-trimethylbenzophenone

(d) 2,4,6-trimethylbenzoyldiphenylphosphine oxide,

(e) phenyl-bis-(2,4,6-trimethylbenzoyl)phosphine oxide, and

(f) 2-hydroxy-2-methyl-1-phenylpropanone

absorbs sufficient energy from both xenon flash lamps and mercury vapor lamps, particularly medium pressure mercury vapor lamps, to cure a photopolymerizable composition.

While not wishing to be bound by theory, it is believed that this combination of photoinitiators (1)-(3) and particularly the combination of photoinitiators (a)-(f) absorb unexpectedly well at the wavelengths of energy emitted from both xenon flash lamps and mercury vapor lamps.

In a preferred embodiment, the combination of photoinitiators comprises from about 20 to about 30% by weight of phenyl-bis-(2,4,6-trimethylbenzoyl)phosphine oxide. In another preferred embodiment, the combination of photoinitiators comprises about 70 to about 80% by weight of a combination of photoinitiator (a), photoinitiator (d), and a eutectic mixture of photoinitiators (b) and (c). In yet another preferred embodiment, the combination of photoinitiators comprises about 70 to about 80% by weight of ESACURE KTO 46, a liquid blend consisting of photoinitiators (a)-(d) and (f), and from about 20 to about 30% by weight of phenyl-bis-(2,4,6-trimethylbenzoyl)phosphine oxide.

A composition, particularly an ink, containing the combination of photoinitiators (a)-(f) of the invention and photopolymerizable materials can be cured well with either xenon flash lamps or mercury vapor lamps, or using both xenon flash lamps and mercury vapor lamps. The composition preferably contains at least about 6% by weight, more preferably at least about 8% by weight, of the combination of photoinitiators (a)-(f). The composition preferably contains no more than about 14% by weight, more preferably not more than about 12% by weight of the combination of photoinitiators (a)-(f).

The inks of the invention are preferably free from unreactive volatile organic compounds. The photopolymerizable materials of the inks may be selected from photopolymerizable monomers, photopolymerizable oligomers, and combinations of these. The photopolymerizable monomers in turn may be selected from monofunctional monomers, polyfunctional monomers, and combinations of these. Suitable example of photopolymerizable monofunctional monomers include, without limitation, alkyl (meth)acrylates and combinations of these, preferably an alkyl (meth)acrylate in which the alkyl group has at least 8 carbon atoms and is preferably branched. Preferred alkyl (meth)acrylates are those that have a surface tension in the range from about 28 to about 29 dynes/cm and a viscosity in the range from about 5 to about 7 centipoise. Examples of suitable alkyl (meth)acrylates include, without limitation, isodecyl acrylate, isodecyl methacrylate, isooctyl acrylate, tridecyl acrylate, tridecyl methacrylate, and combinations of these. Preferred among these is isodecyl acrylate.

Examples of suitable polyfunctional monomers include, without limitation alkylenediol di(meth)acrylates such as 1,6-hexanediol diacrylate and neopentyl glycol diacrylate, cyclohexanedimethanol diacrylate, polyalkylene glycol di(meth)acrylates such as triethylene glycol diacrylate, ether modified monomers such as propoxylated neopentyl glycol diacrylate, and higher functionality monomers such as trimethylolpropane triacrylate, trimethylolethane triacrylate, and pentaerythritol tetracrylate, and so on, as well as combinations of such polyfunctional monomers.

Examples of suitable reactive oligomers include, without limitation, oligomers having at least one, preferably more than one, ethylenically unsaturated double bonds, such as acrylated epoxy oligomers, acrylated polyurethane oligomers, acrylated polyesters, and combinations of these. Preferred oligomers have average functionality of from about 1.6 to about 2.0. It is also preferred to use oligomers having molecular weight between about 300 and about 500. The ink may contain up to about 6.0% by weight of the reactive oligomer, preferably from about 2.0% to about 5.0% by weight of the reactive oligomer, more preferably from about 2.5% to about 4.0% by weight of the reactive oligomer.

The pigment or pigments in the ink may be any of those suitable for ink jet inks. In general, pigments for ink jet inks have a maximum particle size that is small enough to avoid clogging the ink jets during printing. The pigments preferably have a narrow particle size distribution. Among those that may be mentioned are C.I. Pigment Yellow 93, 95, 109, 110, 120, 128, 138, 139, 151, 154, 155, 173, 180, 185 and 193; C.I. Pigment Orange 34, 36, 43, 61, 63 and 71; C.I. Pigment Red 122, 202, 254, and a solid solution of C.I. Pigment Red 122 and 202; C.I. Pigment Blue 15:3 and 15:4; C.I. Pigment Violet 19, 23 and 33; C.I. Pigment Black 7. The ink jet inks are preferably used in a set that provides for full-color printing of images. In one preferred embodiment, an ink set including cyan, magenta, yellow, and black (CMYK) inks is used. For example, yellow, C.I. Pigment Yellow 138, 151, 154, 180 and 185 may be used in the yellow ink; C.I. Pigment Red 122 and 202, 254, and C.I. Pigment Violet 19 may be used in the magenta ink; C.I. Pigment Blue 15 may be used in the cyan ink; and an acidic or neutral pigment of C.I. Pigment Black 7 may be used in the black ink.

The pigments may be provided with a surface treatment to aid in dispersing the pigment and/or in stabilizing the dispersion of the pigment. In general, no separate dispersants are needed. In particular, surfactants and dispersants should not be included at levels that affect the surface tension of the ink, as changing the surface tension of ink may adversely affect the quality of the print by making it difficult to control drop spread. In other cases it may be advantageous to include a modest amount of a dispersant, for example to use a solution of a high molecular weight block copolymer as a stabilizing agent with yellow pigments.

The amount of pigment included in the ink will depend on, for example, which pigment is used. In general, the ink jet ink contains from about 0.5 to about 15% by weight of pigment. While a sufficient amount of pigment is included to attain the desired color density of the ink, including more pigment also tends to increase viscosity. Suitable pigments are available, for example and without limitation, from Clariant Corporation of Coventry, R.I. and Ciba Specialty Chemicals Corp. of Basel, Switzerland.

Before being added to the ink, the pigment is first dispersed in one or more of the radiation curable components of the ink and/or a pigment dispersant compound. Preferably, the pigment is dispersed in a mixture of reactive monomer, reactive oligomer, and, optionally, a pigment dispersant. The dispersion may be made using typical pigment milling techniques and equipment.

The ink may further include suitable additives, such as dyes, and/or plasticizers. If the ink is formulated as a CIJ (continuous ink jet) ink, then an electrolyte is added to the ink. The ink jet ink may contain a small amount of absorbed water, but water is not a substantial component of the solvent package and the ink is nonaqueous.

The ink of the invention may be prepared by blending one or more pigment dispersions, the photoinitiator combination (a)-(f), the photopolymerizable material(s), and any further additive(s).

The ink of the invention is preferably an ink jet ink that may be printed with drop-on-demand (impulse) ink jet printers, valve-jet printers, or, if an electrolyte is included and the ink viscosity adjusted appropriately, with continuous stream ink jet printers. In continuous stream ink jet systems, ink is emitted in a continuous stream under pressure through at least one orifice or nozzle. The stream is perturbed by a piezoelectric transducer, causing it to break up into droplets at a fixed distance from the orifice. At this break-up point, the droplets are charged according to digital data signals. These droplets then pass through an electrostatic field that adjusts the trajectory of each drop, directing the drop either to a specific location on the substrate or back to a gutter for recirculation. In drop-on-demand ink jet printers, a droplet is expelled under pressure from the print head directly to a position on the substrate according to digital data signals. The droplet is formed and expelled only when it is to be jetted onto the substrate.

A full-color image can be printed with an ink jet printer employing an ink set of the invention, such as cyan, magenta, yellow, and black inks (CMYK). The inks of the invention may be formulated in other or in additional colors to make a desired ink set for full-color printing.

### EXAMPLES

### Example 1

Ink Jet Ink According to the Invention

A mixture of 33.7 parts by weight of propoxylated neopentyl glycol diacrylate, 26.5 parts by weight of 1,6-hexanediol diacrylate, 19 parts by weight of isodecyl acrylate, 3.0 parts by weight Byk 348 solution (10% by weight Byk 348, an ether modified polydimethyl siloxane, in propoxylated neopentyl glycol diacrylate), 6.5 parts by weight of a cyan pigment base (35.7% by weight Pigment 15:4 dispersed in a mixture of a pigment dispersant and an epoxy acrylate oligomer), and 14.0 parts by weight of a photoinitiator package prepared by combining 75% by weight ESACURE KTO 46 (available from Lamberti spa Chemical Specialites) and 25% by weight IRGACURE 819 (available from Ciba Specialty Chemicals, Inc, Basel, Switzerland) were combined and mixed with a high shear disperser 60 minutes. The ink had a viscosity of 13.2 centipoise at 25° C.

The ink was printed onto a vinyl substrate and cured using both xenon flash and mercury vapor lamps. Two passes for a xenon flash, 35 Hz lamp yielded the necessary cure-to-touch and adhesion to the vinyl substrate according to ASTM# D-3359-87. The printed ink was also cured with at least one pass at 100 fpm under a mercury vapor lamp with a 120 W/cm bulb or two passes yielding a range of about 80-150 mJ/cm energy yields with cure-to-touch and passed adhesion testing according to ASTM# D-3359-87.

The description of the invention is merely exemplary in nature and, thus, variations that do not depart from the gist of the invention are intended to be within the scope of the invention. Such variations are not to be regarded as a departure from the spirit and scope of the invention.

1. A combination of photoinitiators, wherein said combination of photoinitiators can absorb sufficient energy emitted from either a mercury vapor lamp or a xenon flash lamp to cure a photopolymerizable composition.

2. A combination of photoinitiators according to claim 1, comprising
(a) a member selected from the group consisting of 2-hydroxy-2-methyl-1-phenylpropanone, derivatives of 2-hydroxy-2-methyl-1-phenylpropanone, and combinations thereof;
(b) a member selected from the group consisting of alkyl-substituted benzophenones and combinations thereof; and
(c) phenyl-bis-(2,4,6-trimethylbenzoyl)phosphine oxide, optionally in combination with a member selected from the group consisting of 2,4,6-trimethylbenzoyldiphenylphosphine oxide and substituted 2,4,6-trimethylbenzoyldiphenylphosphine oxides different from phenyl-bis-(2,4,6-trimethylbenzoyl)phosphine oxide.

3. An ink, comprising a photopolymerizable material and the combination of photoinitiators of claim 1.

4. An ink, comprising a photopolymerizable material and the combination of photoinitiators of claim 2.

5. A combination of photoinitiators for a photopolymerizable composition, comprising a liquid blend of
(a) oligo [2-hydroxy-2-methyl-1-[4-(1-methylvinyl)phenyl]propanone]
(b) 4-methylbenzophenonone
\mathring{c} 2,4,6-trimethylbenzophenone
(d) 2,4,6-trimethylbenzoyldiphenylphosphine oxide,
(e) phenyl-bis-(2,4,6-trimethylbenzoyl)phosphine oxide, and
(f) 2-hydroxy-2-methyl-1-phenylpropanone.

6. A photopolymerizable composition, comprising a photopolymerizable material and a liquid blend of
(a) oligo [2-hydroxy-2-methyl-1-[4-(1-methylvinyl)phenyl]propanone]
(b) 4-methylbenzophenonone
(c) 2,4,6-trimethylbenzophenone
(d) 2,4,6-trimethylbenzoyldiphenylphosphine oxide,
(e) phenyl-bis-(2,4,6-trimethylbenzoyl)phosphine oxide, and
(f) 2-hydroxy-2-methyl-1-phenylpropanone.

7. An ink jet ink, comprising a photopolymerizable material, a pigment, and a liquid blend of
(a) oligo [2-hydroxy-2-methyl-1-[4-(1-methylvinyl)phenyl]propanone]
(b) 4-methylbenzophenonone
(c) 2,4,6-trimethylbenzophenone
(d) 2,4,6-trimethylbenzoyldiphenylphosphine oxide,
(e) phenyl-bis-(2,4,6-trimethylbenzoyl)phosphine oxide, and
(f) 2-hydroxy-2-methyl-1-phenylpropanone.

8. An ink jet ink according to claim 7, wherein the photopolymerizable material is selected from the group consisting of photopolymerizable monomers and photopolymerizable oligomers, and further wherein the liquid blend comprises from about 20 to about 30% by weight of phenyl-bis-(2,4,6-trimethylbenzoyl)phosphine oxide and from about 70 to about 80% by weight of a combination of oligo [2-hydroxy-2-methyl-1-[4-(1-methylvinyl)phenyl]propanone], 2,4,6-trimethylbenzoyldiphenylphosphine oxide, and a eutectic mixture of 4-methylbenzophenonone and 2,4,6-trimethylbenzophenone.
